(19) United States
(12) Patent Application Publication
(10) Pub. No.: US 2024/0386068 A1
(43) Pub. Date: Nov. 21, 2024

(54) DEEPWEB ENTITY RECOGNITION METHOD, APPARATUS, DEVICE, AND MEDIUM BASED ON UNIQUENESS CONSTRAINT

(71) Applicant: Beijing Hydrophis Network Technology Co., Ltd., Beijing (CN)

(72) Inventor: Feng Hong, Beijing (CN)

(21) Appl. No.: 18/599,426

(22) Filed: Mar. 8, 2024

(30) Foreign Application Priority Data
May 17, 2023 (CN) 202310558330.1

(51) Int. Cl. G06F 16/954; G06F 16/955; G06F 18/22

(52) U.S. Cl. CPC G06F 16/954; G06F 16/955; G06F 18/22

(57) ABSTRACT

The present invention discloses a DeepWeb entity recognition method based on a uniqueness constraint, including: performing structure conversion on an entity object set to obtain an entity object attribute set of a DeepWeb; calculating a matching degree between entity objects in the entity object attribute set, and constructing a matching list of the entity object set according to the matching degree; filtering the matching list to obtain an entity class cluster; calculating an object similarity degree of each entity object in the entity class cluster, and merging the entity class cluster according to the object similarity degree to obtain the entity class set; searching a uniqueness constraint corresponding to each entity object in the entity object set according to the entity class set, and recognizing an entity object in the DeepWeb according to the uniqueness constraint. The present invention can improve the accuracy of entity recognition in DeepWebs.

### CROSS REFERENCE TO RELATED APPLICATIONS

The present application claims the benefit of Chinese Patent Application No. 202310558330.1 filed on May 17, 2023, the contents of which are incorporated herein by reference in their entirety.

### TECHNICAL FIELD

The present invention relates to the technical field of entity recognition, and more particularly to a DeepWeb entity recognition method, apparatus, device, and medium based on a uniqueness constraint.

### BACKGROUND

The entire global broad web can be divided into two parts: Surface Web and DeepWeb according to the “depth” of the information it contains. SurfaceWeb refers to the collection of pages that can be indexed by traditional search engines through hyperlinks, and DeepWeb refers to the part of the Web that cannot be indexed by traditional search engines. With the increasing maturity of Web-related technologies and the rapid growth of the amount of information contained in DeepWeb, many fields have a large number of data sources, and some of the data overlap. Different data sources provide information about the same entity, and access to web databases has gradually become the main means of acquiring information, research on DeepWeb has also attracted more and more attention.

In practice, many attributes satisfy the uniqueness constraint, namely, each entity (or most entities) has a unique value at these attributes, including DeepWeb entities; however, since some data sources provide wrong attribute values, resulting in that these attribute data do not all satisfy the uniqueness constraint, and thus resulting in an error in entity recognition, a conventional entity recognition method is generally divided into two steps: record linkage and data fusion, i.e. connecting sets of records that may point to the same entity and merging each set of records, and resolving possible data conflicts for attributes of each entity to determine correct attribute values, but incorrect attribute values may result in incorrect entity recognition, while other correct attribute values may be missed, resulting in low accuracy of DeepWeb entity recognition.

### SUMMARY

The present invention provides a DeepWeb entity recognition method, apparatus, device, and medium based on a uniqueness constraint, the main object of which is to solve the problem of low accuracy in DeepWeb entity recognition.

In order to realize the above-mentioned object, the present invention provides a DeepWeb entity recognition method based on a uniqueness constraint, including:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

Optionally, the performing structure conversion on the entity object set to obtain an entity object attribute set of the DeepWeb includes:
acquiring an attribute list of each entity object in the entity object set, and extracting an object list with the same attribute value in the attribute list;
performing attribute structure conversion on the entity object set according to the object list to obtain an entity object attribute set of the DeepWeb.

Optionally, the calculating a matching degree between entity objects in the entity object attribute set includes:
extracting a target entity object with the same attribute value in the entity object attribute set, and acquiring the number of attributes of the target entity object;
calculating a target matching degree of the target entity object according to the number of attributes and the same attribute value using the following formula, and determining a matching degree between the entity objects according to the target matching degree;

$$Mat ( {O}_{1} , {O}_{2} ) = \frac{\vert {O}_{1} ∩ {O}_{2} \vert}{\vert {O}_{1} \vert + \vert {O}_{2} \vert - \vert {O}_{1} ∩ {O}_{2} \vert}$$

wherein, Mat(O₁, O₂) represents the target matching degree between target entity objects O₁, O₂, |O₁∩O₂| represents the number of identical attribute values between target entity objects O₁, O₂, |O₁| represents the number of attributes in the target entity objects O₁, and |O₂| represents the number of attributes in the target entity objects O₂.

Optionally, constructing a matching list of the entity object set according to the matching degree includes:
extracting a matching entity object of each entity object from the entity object set according to the matching degree, and sorting the matching entity objects according to the numerical value of the matching degree to obtain a matching object sequence of each entity object;
constructing an initial matching list of each of the entity objects according to the matching object sequence, and combining the initial matching lists to obtain a matching list of the entity object set.

Optionally, the using a pre-set matching degree threshold value to filter the matching list to obtain an entity class cluster of the entity object set includes:
searching a matching relationship of each entity object from the matching list, and when the matching relationship is a multi-matching relationship, acquiring a matching degree of each matching relationship;
deleting a matching relationship corresponding to the matching degree to obtain an updated matching list when the matching degree is less than a pre-set matching degree threshold value;
classifying the entity object set according to the updated matching list to obtain an entity class cluster of the entity object set.

Optionally, the calculating an object similarity degree of each entity object in the entity class cluster includes:
calculating an attribute occurrence frequency of a target entity attribute corresponding to each entity object in the entity class cluster, and calculating an attribute weight of the target entity attribute according to the attribute occurrence frequency;
calculating an attribute similarity degree between the target entity attributes according to the data type of the target entity attributes using the following formula;

$$Sim ( {a}_{1} , {a}_{2} ) = \{ \begin{matrix}\vert {a}_{1} ⋂ {a}_{2} \vert / \vert {a}_{1} ⋃ {a}_{2} \vert & {a}_{1} , {a}_{2} is numeric type \\ \vert {a}_{1} ⋂ {a}_{2} \vert / min ( \vert {a}_{1} \vert , \vert {a}_{2} \vert ) & {a}_{1} , {a}_{2} is character type \\ 1 & others\end{matrix}$$

wherein, Sim(a₁, a₂) represents the attribute similarity degree between the target entity attributes a₁, a₂, |a₁∩a₂| represents the absolute value of the intersection set of the target entity attributes a₁, a₂, |a₁∪a₂| represents the absolute value of the union set of the target entity attributes a₁, a₂, and min(|a₁|, |a₂|) represents the minimum value of the absolute values of the target entity attributes a₁, a₂;
calculating an object similarity degree of each entity object in the entity class cluster according to the attribute weight and the attribute similarity degree.

Optionally, the calculating an object similarity degree of each entity object in the entity class cluster according to the attribute weight and the attribute similarity degree includes:
calculating an object similarity degree of each entity object in the entity class cluster using the following formula:

$$Sim ( {P}_{1} , {P}_{2} ) = \frac{{\sum }_{i = 1}^{I} {w}_{i} * max ( {Sim}_{i} ( {P}_{1} , {P}_{2} ) )}{min ( \vert {P}_{1} \vert , \vert {P}_{2} \vert )}$$

Wherein, Sim(P₁, P₂) represents the object similarity degree between entity objects P₁, P₂ in an entity class cluster, Simᵢ(P₁, P₂) represents the attribute similarity degree between a i^{th} target entity attribute and other target entity attributes in the entity objects P₁, P₂, i represents the i^{th} target entity attribute in the entity objects P₁, P₂, I represents the total number of target entity attributes, max(Simᵢ(P₁, P₂)) represents the maximum value of the attribute similarity degree between the i^{th} target entity attribute and other target entity attributes in the entity objects P₁, P₂, wᵢ represents the attribute weight corresponding to the i^{th} target entity attribute in the entity objects P₁, P₂, |P₁| represents the number of attributes in the entity object P₁ in the entity class cluster, and |P₂| represents the number of attributes in the entity object P₂ in the entity class cluster.

In order to solve the above problems, the present invention also provides a DeepWeb entity recognition apparatus based on a uniqueness constraint, the apparatus includes:
an entity object structure conversion module for acquiring an entity object set in a DeepWeb, and performing structure conversion on the entity object set to obtain an entity object attribute set of the DeepWeb;
a matching list construction module for calculating a matching degree between entity objects in the entity object attribute set, and constructing a matching list of the entity object set according to the matching degree;
a matching list filtering module for using a pre-set matching degree threshold value to filter the matching list to obtain an entity class cluster of the entity object set;
an entity class set generation module for calculating an object similarity degree of each entity object in the entity class cluster, and merging the entity class cluster according to the object similarity degree to obtain an entity class set of the entity object set;
an entity recognition module for searching a uniqueness constraint corresponding to each entity object in the entity object set according to the entity class set, and recognizing an entity object in the DeepWeb according to the uniqueness constraint.

In order to solve the above problems, the present invention also provides an electronic device including:
at least one processor; and,
a memory communicatively connected to the at least one processor; wherein,
the memory stores a computer program executable by the at least one processor, the computer program being executable by the at least one processor to enable the at least one processor to perform the DeepWeb entity recognition method based on a uniqueness constraint as described above.

To solve the above problems, the present invention also provides a computer-readable storage medium having stored therein at least one computer program executed by a processor in an electronic device to realize the DeepWeb entity recognition method based on a uniqueness constraint as described above.

An embodiment of the present invention obtains an entity object attribute set by performing structure conversion on an entity object set in a DeepWeb and can convert a set organized by objects into an organized by attributes so that a matching degree between attributes of each entity object can be calculated, and then a matching list of the entity object attribute set is constructed; using a pre-set matching degree threshold value to filter the matching list and to remove irrelevant matching relationships so as to obtain a more accurate entity class cluster, then calculating the object similarity degree of each entity object in the entity class cluster, and further classifying the entity objects so as to realize the classification of entity objects of different categories; by searching the uniqueness constraint corresponding to each entity object in the entity class set, accurate entity recognition can be realized according to the uniqueness constraint. Therefore, the DeepWeb entity recognition method, apparatus, electronic device, and computer-readable storage medium based on a uniqueness constraint proposed by the present invention can solve the problem of low accuracy when performing DeepWeb entity recognition.

### BRIEF DESCRIPTION OF THE ACCOMPANYING DRAWINGS

FIG. 1 is a flow diagram of a DeepWeb entity recognition method based on a uniqueness constraint provided by an embodiment of the present invention;

FIG. 2 is a flow diagram of filtering a matching list according to an embodiment of the present invention;

FIG. 3 is a flow diagram for calculating object similarity degree of each entity object according to an embodiment of the present invention;

FIG. 4 is a functional module diagram of a DeepWeb entity recognition apparatus based on a uniqueness constraint according to an embodiment of the present invention;

FIG. 5 is a structure diagram of an electronic device realizing the DeepWeb entity recognition method based on a uniqueness constraint according to an embodiment of the present invention.

The realization of the purpose, functional features, and advantages of the present invention will be further described with reference to the accompanying drawings in conjunction with the embodiments.

### DETAILED DESCRIPTION OF ILLUSTRATED EMBODIMENTS

It should be understood that the particular embodiments described herein are illustrative only and are not limiting.

Embodiments of the present application provide a DeepWeb entity recognition method based on a uniqueness constraint. The executive body of the DeepWeb entity recognition method based on a uniqueness constraint includes, but is not limited to, at least one electronic device including a service end, a terminal, etc. which can be configured to execute the method provided by the embodiment of the present application. In other words, the DeepWeb entity recognition method based on a uniqueness constraint may be executed by software or hardware installed on a terminal device or a service end device, and the software may be a blockchain platform. The service end includes but is not limited to a single server, a server cluster, a cloud server, or a cloud server cluster, etc. The server can be an independent server, and can also be a cloud server providing basic cloud computing services, such as a cloud service, a cloud database, cloud computing, a cloud function, cloud storage, a network service, cloud communication, a middleware service, a domain name service, a security service, a content delivery network (CDN), and a large data and artificial intelligence platform.

With reference to FIG. 1, a flow diagram of a DeepWeb entity recognition method based on a uniqueness constraint provided by an embodiment of the present invention is shown. In the present embodiment, the DeepWeb entity recognition method based on a uniqueness constraint includes:

S1, acquiring an entity object set in a DeepWeb and performing structure conversion on the entity object set to obtain an entity object attribute set of the DeepWeb.

In an embodiment of the present invention, an entity object in a DeepWeb is described in a structured form with limited attribute information. For example, to describe a paper, attributes such as title, author, and date are usually used, and objects representing the same entity tend to be the same in attribute value. Therefore, objects with the same attribute value are more likely to describe the same entity, and the role of structure conversion is to transform the collection organized by entity objects into organized by attributes, so that objects with the same attribute value are aggregated together, and the goal is to make matching calculation only among potential entity objects, thus effectively reducing the time complexity.

In an embodiment of the present invention, the performing structure conversion on the entity object set to obtain an entity object attribute set of the DeepWeb includes:
acquiring an attribute list of each entity object in the entity object set, and extracting an object list with the same attribute value in the attribute list;
performing attribute structure conversion on the entity object set according to the object list to obtain an entity object attribute set of the DeepWeb.

In an embodiment of the present invention, entity objects with same attribute value are divided into object lists corresponding to the attribute values via an object list, for example, wherein A={O1, O2, . . . , Om} is an object list, indicating that in the objects O1, O2, . . . , Om, the value of the attribute A is the same; therefore, the collection of entity object organizations is converted into organization by attributes, so that the subsequent calculation does not involve the problem of pattern matching between attributes, and the calculation complexity is effectively reduced.

S2, calculating a matching degree between entity objects in the entity object attribute set, and constructing a matching list of the entity object set according to the matching degree.

In an embodiment of the present invention, the matching degree represents a matching degree between entity objects having one and the same attribute value in an entity object set, and the higher the matching degree, the greater the probability that two entity objects are the same entity, so as to construct a matching list of the entity object set according to the matching degree.

In an embodiment of the present invention, the calculating a matching degree between entity objects in the entity object attribute set includes:
extracting a target entity object with the same attribute value in the entity object attribute set, and acquiring the number of attributes of the target entity object;
calculating a target matching degree of the target entity object according to the number of attributes and the same attribute value, and determining a matching degree between the entity objects according to the target matching degree.

In an embodiment of the present invention, a target matching degree between target entity objects with same attribute value is calculated, and the target matching degree is taken as the matching degree between the entity objects; if there is no same attribute value between the entity objects, it indicates that there is no target matching degree between the entity objects, and further indicates that there is no matching relationship between the entity objects.

In an embodiment of the present invention, the target matching degree of the target entity object is calculated using the following formula:

$$Mat ( {O}_{1} , {O}_{2} ) = \frac{\vert {O}_{1} ∩ {O}_{2} \vert}{\vert {O}_{1} \vert + \vert {O}_{2} \vert - \vert {O}_{1} ⋂ {O}_{2} \vert}$$

wherein, Mat(O₁, O₂) represents the target matching degree between target entity objects O₁, O₂, |O₁∩O₂| represents the number of identical attribute values between target entity objects O₁, O₂, |O₁| represents the number of attributes in the target entity objects O₁, and |O₂| represents the number of attributes in the target entity objects O₂.

In an embodiment of the present invention, a matching list is constructed according to the matching degree, the matching relationship between each entity object is displayed in the form of a list, and the matching relationship between each entity object is displayed intuitively.

In an embodiment of the present invention, constructing a matching list of the entity object set according to the matching degree includes:
extracting a matching entity object of each entity object from the entity object set according to the matching degree, and sorting the matching entity objects according to the numerical value of the matching degree to obtain a matching object sequence of each entity object;
constructing an initial matching list of each of the entity objects according to the matching object sequence, and combining the initial matching lists to obtain a matching list of the entity object set.

In an embodiment of the present invention, matching entity objects are sorted from large to small by the numerical value of the matching degree to obtain a matching object sequence, and a matching list of matching objects is constructed through a bidirectional list structure, a matching list of each entity object is combined, and an initial matching list of each entity object in the matching object sequence is combined together, while removing repeated matching relationships to obtain a matching list of an entity object set.

In an embodiment of the present invention, by constructing a matching list of an entity object set, visually showing the matching relationship and the size of the matching degree of each entity object, it is advantageous to distinguish entity objects, thereby improving the accuracy of subsequent entity recognition.

S3, using a pre-set matching degree threshold value to filter the matching list to obtain an entity class cluster of the entity object set.

In an embodiment of the present invention, an entity object may have an attribute value consistent with other entity objects but does not represent the same entity. For example, the year of publication of a paper, the publication unit may be the same as other papers, but they may not point to the same paper. At the same time, the matching degree between these entity objects is usually low, and multiple entity objects are matched at the same time, and then a matching relationship with the matching degree being less than the matching degree threshold value in a matching list is eliminated by using a matching degree threshold value.

In an embodiment of the present invention, the entity class cluster represents an entity object with a high matching degree between attributes of the entity objects and represents that different entity objects in the entity class cluster may have the same attributes of the entity objects so that the entity class cluster is used for subsequently determining the uniqueness constraint of each entity object in the entity object set.

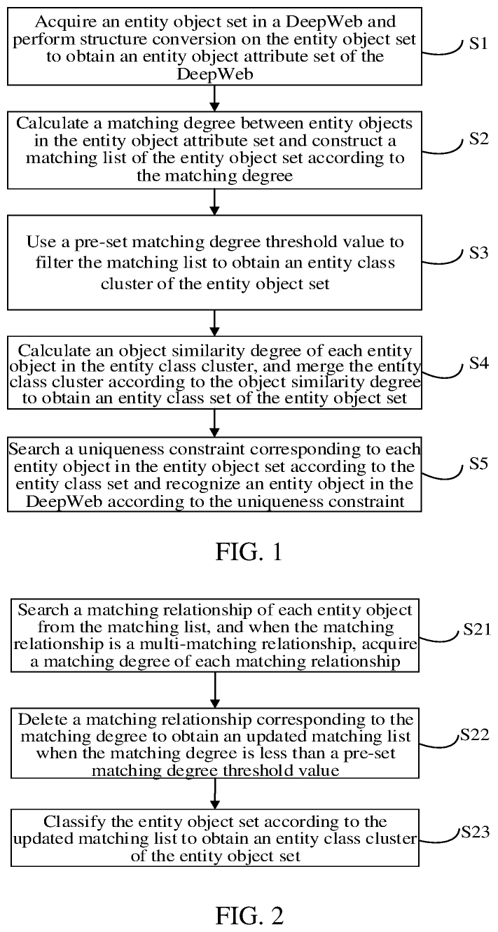

In an embodiment of the present invention, referring to FIG. 2, the using a pre-set matching degree threshold value to filter the matching list to obtain an entity class cluster of the entity object set includes:

S21, searching a matching relationship of each entity object from the matching list, and when the matching relationship is a multi-matching relationship, acquiring a matching degree of each matching relationship;

S22, deleting a matching relationship corresponding to the matching degree to obtain an updated matching list when the matching degree is less than a pre-set matching degree threshold value;

S23, classifying the entity object set according to the updated matching list to obtain an entity class cluster of the entity object set.

In an embodiment of the present invention, an entity object having a co-occurrence attribute value is preliminarily classified by updating a matching list, for example, a pre-set matching degree threshold value is 0.2, a matching relationship with a matching degree being less than 0.2 is removed to obtain an updated matching list, and the entity object matched in the updated matching list is divided into an entity class cluster so that the entity object can be preliminarily recognized according to the attribute value of the entity object.

S4, calculating an object similarity degree of each entity object in the entity class cluster, and merging the entity class cluster according to the object similarity degree to obtain an entity class set of the entity object set.

In an embodiment of the present invention, an entity class cluster is a rough entity class set, that contains class clusters that have not been fully merged, and it is necessary to further mine the similarity of each entity object and to perform secondary classification on the entity object, so as to obtain a more accurate entity class set of the classification result.

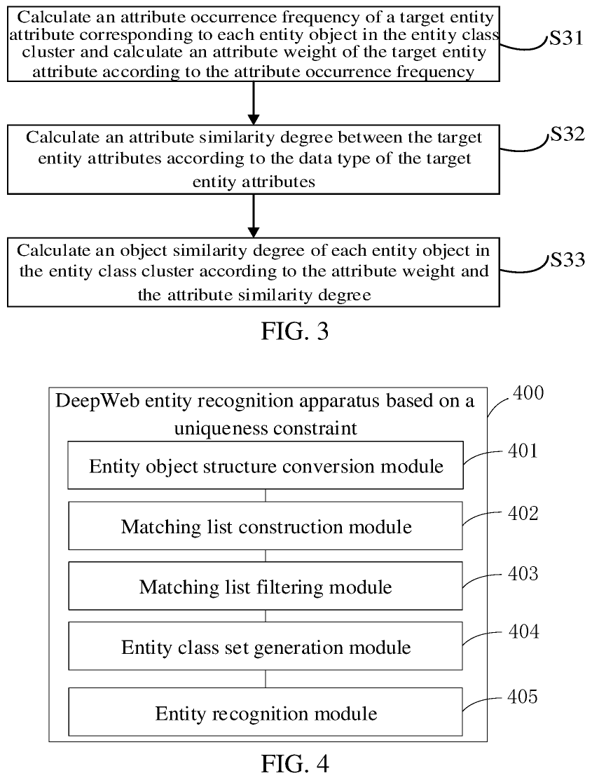

In an embodiment of the present invention, referring to FIG. 3, the calculating an object similarity degree of each entity object in the entity class cluster includes:

S31, calculating an attribute occurrence frequency of a target entity attribute corresponding to each entity object in the entity class cluster, and calculating an attribute weight of the target entity attribute according to the attribute occurrence frequency;

S32, calculating an attribute similarity degree between the target entity attributes according to the data type of the target entity attributes;

S33, calculating an object similarity degree of each entity object in the entity class cluster according to the attribute weight and the attribute similarity degree.

In an embodiment of the present invention, the attribute occurrence frequency of the target entity attribute corresponding to each entity object in the entity class cluster refers to the ratio of the number of occurrences of the target entity attribute divided by the total number of occurrences of all the target entity attributes corresponding to all the entity objects in the entity class cluster. The calculation formula of the attribute weight is:

$${w}_{i} = \frac{{f}_{i}}{{\sum }_{j = 1}^{I} {f}_{j}}$$

wherein, wᵢ represents the attribute weight corresponding to the i^{th} target entity attribute, fᵢ represents the attribute occurrence frequency of the i^{th} target entity attribute, fⱼ represents the attribute occurrence frequency of the j^{th} target entity attribute, and I represents the total number of target entity attributes.

In an embodiment of the present invention, the attribute similarity degree of the target entity attribute is calculated through the data type, the similarity between the attributes is calculated using the attribute instance, and the attribute semantics is described in depth, so using the attribute instance to perform pattern matching helps to enhance the matching accuracy.

The embodiment of the present invention calculates the attribute similarity degree of the target entity attribute using the following formula:

$$Sim ( {a}_{1} , {a}_{2} ) = \{ \begin{matrix}\vert {a}_{1} ⋂ {a}_{2} \vert / \vert {a}_{1} ⋃ {a}_{2} \vert & {a}_{1} , {a}_{2} is numeric type \\ \vert {a}_{1} ⋂ {a}_{2} \vert / min ( \vert {a}_{1} \vert , \vert {a}_{2} \vert ) & {a}_{1} , {a}_{2} is character type \\ 1 & others\end{matrix}$$

wherein, Sim(a₁, a₂) represents the attribute similarity degree between the target entity attributes a₁, a₂, |a₁∩a₂| represents the absolute value of the intersection set of the target entity attributes a₁, a₂, |a₁∪a₂| represents the absolute value of the union set of the target entity attributes a₁, a₂, and min(|a₁|, |a₂|) represents the minimum value of the absolute values of the target entity attributes a₁, a₂.

In an embodiment of the present invention, an object similarity degree of each entity object in an entity class cluster is calculated by an attribute weight and an attribute similarity degree, and each entity object in the entity class cluster is further distinguished, thereby recognizing the entity object more accurately.

In an embodiment of the present invention, the object similarity degree of each entity object in the entity class cluster is calculated using the following formula:

$$Sim ( {P}_{1} , {P}_{2} ) = \frac{{\sum }_{i = 1}^{I} {w}_{i} * max ( {Sim}_{i} ( {P}_{1} , {P}_{2} ) )}{min ( \vert {P}_{1} \vert , \vert {P}_{2} \vert )}$$

Wherein, Sim(P₁, P₂) represents the object similarity degree between entity objects P₁, P₂ in an entity class cluster, Simᵢ(P₁, P₂) represents the attribute similarity degree between a i^{th} target entity attribute and other target entity attributes in the entity objects P₁, P₂, i represents the i^{th} target entity attribute in the entity objects P₁, P₂, I represents the total number of target entity attributes, max (Simᵢ(P₁, P₂)) represents the maximum value of the attribute similarity degree between the i^{th} target entity attribute and other target entity attributes in the entity objects P₁, P₂, wᵢ represents the attribute weight corresponding to the i^{th} target entity attribute in the entity objects P₁, P₂, |P₁| represents the number of attributes in the entity object P₁ in the entity class cluster, and |P₂| represents the number of attributes in the entity object P₂ in the entity class cluster.

In an embodiment of the present invention, entity objects with an object similarity degree greater than a pre-set similarity threshold value in an entity class cluster are merged through the object similarity degree, that is, entity objects with an object similarity degree greater than a pre-set similarity threshold value are further clustered to obtain an entity class set of an entity object set.

In an embodiment of the present invention, entity objects in a DeepWeb are deep class-cluster merged by an entity class set, and entity objects possibly recognized as the same entity object are merged into the same entity class set, so that the uniqueness constraint of each entity object can be found out when searching, thereby improving the accuracy of entity object recognition.

S5, searching a uniqueness constraint corresponding to each entity object in the entity object set according to the entity class set, and recognizing an entity object in the DeepWeb according to the uniqueness constraint.

In an embodiment of the present invention, the uniqueness constraint represents an attribute value of which each entity in an entity class set has a unique value in an attribute of an entity object, and the unique attribute value is taken as the uniqueness constraint corresponding to each entity object in the entity object set; specifically, the unique attribute value corresponding to each entity object can be searched according to the entity class set to obtain the uniqueness constraint corresponding to each entity object.

In an embodiment of the present invention, entity recognition in a DeepWeb is usually recognized by attribute values of attributes of an entity object, for example, the year of publication of a paper, the title of the paper, etc. but these attribute values are easily repeated with other entity objects, resulting in an erroneous entity object recognition result, and therefore, entity objects in a DeepWeb can be recognized using a uniqueness constraint, thereby realizing more accurate entity object recognition.

An embodiment of the present invention obtains an entity object attribute set by performing structure conversion on an entity object set in a DeepWeb and can convert a set organized by objects into an organized by attributes so that a matching degree between attributes of each entity object can be calculated, and then a matching list of the entity object attribute set is constructed; using a pre-set matching degree threshold value to filter the matching list and to remove irrelevant matching relationships so as to obtain a more accurate entity class cluster, then calculating the object similarity degree of each entity object in the entity class cluster, and further classifying the entity objects so as to realize the classification of entity objects of different categories; by searching the uniqueness constraint corresponding to each entity object in the entity class set, accurate entity recognition can be realized according to the uniqueness constraint. Therefore, the DeepWeb entity recognition method based on a uniqueness constraint proposed by the present invention can solve the problem of low accuracy when performing DeepWeb entity recognition.

FIG. 4 is a functional module diagram of a DeepWeb entity recognition apparatus based on a uniqueness constraint according to an embodiment of the present invention.

The DeepWeb entity recognition apparatus 400 based on a uniqueness constraint according to the present invention can be installed in an electronic device. According to the realized functions, the DeepWeb entity recognition apparatus 400 based on a uniqueness constraint may include an entity object structure conversion module 401, a matching list construction module 402, a matching list filtering module 403, an entity class set generation module 404, and an entity recognition module 405. A module according to the present invention, which may also be referred to as a unit, refers to a series of computer program segments capable of being executed by a processor of an electronic device and capable of performing fixed functions, which are stored in a memory of the electronic device.

In the present embodiment, the functions of each module/unit are as follows:
the entity object structure conversion module 401 is used for acquiring an entity object set in a DeepWeb, and performing structure conversion on the entity object set to obtain an entity object attribute set of the DeepWeb;
the matching list construction module 402 is used for calculating a matching degree between entity objects in the entity object attribute set, and constructing a matching list of the entity object set according to the matching degree;
the matching list filtering module 403 is used for using a pre-set matching degree threshold value to filter the matching list to obtain an entity class cluster of the entity object set;
the entity class set generation module 404 is used for calculating an object similarity degree of each entity object in the entity class cluster, and merging the entity class cluster according to the object similarity degree to obtain an entity class set of the entity object set; and
the entity recognition module 405 is used for searching a uniqueness constraint corresponding to each entity object in the entity object set according to the entity class set and recognizing an entity object in the DeepWeb according to the uniqueness constraint.

In detail, each module described in the DeepWeb entity recognition apparatus 400 based on a uniqueness constraint in the embodiment of the present invention uses the same technical means as the DeepWeb entity recognition method based on a uniqueness constraint described in the above-mentioned FIG. 1 to FIG. 3 and can produce the same technical effect, and the description thereof will not be repeated here.

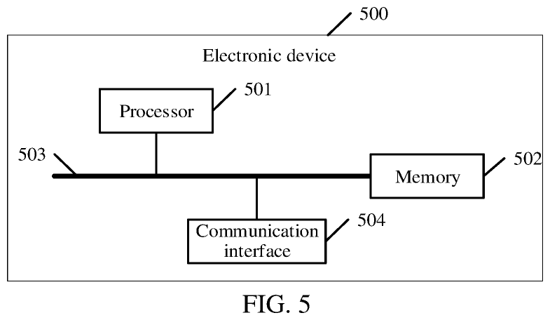

FIG. 5 is a block diagram of an electronic device realizing a DeepWeb entity recognition method based on a uniqueness constraint according to an embodiment of the present invention.

The electronic device 500 may include a processor 501, a memory 502, a communication bus 503, and a communication interface 504, and may include a computer program stored in the memory 502 and run on the processor 501, such as a DeepWeb entity recognition program based on a uniqueness constraint.

Wherein, the processor 501 may, in some embodiments, be included in an integrated circuit, such as a single packaged integrated circuit, or a plurality of integrated circuits packaged with the same or different functions, including one or more central processing units (CPU), microprocessors, digital processing chips, graphics processors, combinations of various control chips, etc. The processor 501 is a control unit of the electronic device, connects various components of the entire electronic device using various interfaces and lines, performs various functions of the electronic device, and processes data by running or executing programs or modules stored in the memory 502 (e.g. executing DeepWeb entity recognition programs based on a uniqueness constraint, etc.), and calling data stored in the memory 502.

The memory 502 includes at least one type of readable storage medium, and the readable storage medium includes flash memory, a mobile hard disk, a multimedia card and a card-type memory (for example: SD or DX memory, etc.), magnetic memory, magnetic disk, optical disk, etc. The memory 502 may in some embodiments be an internal storage unit of the electronic device, such as a mobile hard disk of the electronic device. The memory 502 may also be an external storage device of the electronic device in other embodiments, such as a plug-in mobile hard disk, a smart media card (SMC), a secure digital (SD) card, a flash card, etc. provided on the electronic device. Further, the memory 502 may include both an internal storage unit and an external storage device of the electronic device. The memory 502 may be used not only to store application software installed in an electronic device and various types of data, such as codes of a DeepWeb entity recognition program based on a uniqueness constraint but also to temporarily store data that has been output or is to be output.

The communication bus 503 may be a peripheral component interconnect (PCI) bus, or an extended industry standard architecture (EISA) bus or the like. The bus may be divided into an address bus, a data bus, a control bus, etc. The bus is arranged to realize the connection communication between the memory 502 and at least one processor 501 etc.

The communication interface 504 is used for communication between the electronic device and other devices, including network interfaces and user interfaces. Optionally, the network interface may include a wired interface and/or a wireless interface (e.g. a WI-FI interface, a Bluetooth interface, etc.), typically for establishing a communication connection between the electronic device and other electronic devices. The user interface may be a display, an input unit (such as a keyboard), optionally, a standard wired interface, or a wireless interface. Optionally, in some embodiments, the display may be an LED display, a liquid crystal display, a touch-sensitive liquid crystal display, an OLED (Organic Light-Emitting Diode) touchpad, or the like. Where appropriate, the display may also be referred to as a display screen or display unit for displaying information processed in the electronic device and for displaying a visualized user interface.

While only electronic devices having components are shown in the figures, those skilled in the art will appreciate that the structures shown in the figures are not to be construed as limiting the electronic devices and may include fewer or more components than those shown, or some components in combination, or different arrangements of components.

For example, although not shown, the electronic device may also include a power source (e.g. a battery) to power the various components. Preferably, the power source may be logically connected to the at least one processor 501 through the power management apparatus to realize charging management, discharging management, and power consumption management functions through the power management apparatus. The power supply may also include one or more of a DC or AC power source, a recharging device, a power failure detection circuit, a power converter or inverter, a power status indicator, and any other component. The electronic device may also include various sensors, Bluetooth modules, Wi-Fi modules, etc. which will not be described in detail herein.

It should be understood that the examples are for illustrative purposes only and are not to be construed as limiting the scope of the patent application.

The DeepWeb entity recognition program based on a uniqueness constraint stored in the memory 502 in the electronic device 500 is a combination of a plurality of instructions, and when running in the processor 501, can realize:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

Specifically, the specific implementation of the above instructions by the processor 501 may refer to the description of the relevant steps in the corresponding embodiments of the figures, which will not be repeated here.

Further, the integrated modules/units of the electronic device 500, if realized in the form of software functional units and sold or used as stand-alone products, may be stored in a computer-readable storage medium. The computer-readable storage medium can be volatile or non-volatile. For example, the computer-readable medium may include any entity or apparatus, recording medium, U disk, removable hard disk, magnetic disk, optical disk, computer memory, or read-only memory (ROM), capable of carrying the computer program code.

The present invention also provides a computer-readable storage medium storing a computer program which, when executed by a processor of an electronic device, realizes:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

In several embodiments provided by the present invention, it should be understood that the disclosed apparatus, device, and method may be realized in other ways. For example, the apparatus embodiments described above are merely illustrative, e.g. the division of modules is only a logical function division, and there may be other division methods in actual realization.
the modules illustrated as separate components may or may not be physically separated, the components shown as modules may or may not be physical units, i.e. may be located in one place, or may also be distributed over a plurality of network elements. Some or all of the modules may be selected to realize the objectives of the embodiments according to actual needs.

In addition, various functional modules in various embodiments of the present invention may be integrated in one processing unit, may be physically present in separate units, or may be integrated in one unit in two or more units. The above-mentioned integrated units can be realized in the form of hardware or the form of hardware plus software functional modules.

It will be evident to those skilled in the art that the invention is not limited to the details of the foregoing illustrative embodiments, and that the present invention may be realized in other specific forms without departing from the spirit or essential characteristics thereof.

The present embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein. Any reference signs in the claims shall not be construed as limiting the claim concerned.

Embodiments of the present application may acquire and process relevant data based on artificial intelligence techniques. Among them, artificial intelligence (AI) is a theory, method, technology, and application system that uses a digital computer or digital computer-controlled machine to simulate, extend, and expand human intelligence, perceive the environment, acquire knowledge, and use the knowledge to obtain the best results.

Furthermore, it will be understood that the word “comprise” or “include” does not exclude other units or steps and the singular does not exclude the plural. A plurality of the units or apparatus recited in the system claims may also be realized by one unit or apparatus by software or hardware. The terms first, second, etc. are used to refer to names and do not denote any particular order.

Finally, it is to be understood that the above-described embodiments are merely illustrative of the present invention and not restrictive, although the present invention has been described in detail with reference to preferred embodiments. It will be understood by those of ordinary skill in the art that changes may be made or equivalents may be substituted for elements thereof without departing from the spirit and scope of the invention.

What is claimed is:

1. A DeepWeb entity recognition method based on a uniqueness constraint, the method comprising:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

2. The DeepWeb entity recognition method based on a uniqueness constraint of claim 1, wherein the performing structure conversion on the entity object set to obtain an entity object attribute set of the DeepWeb comprises:
acquiring an attribute list of each entity object in the entity object set, and extracting an object list with same attribute value in the attribute list;
performing attribute structure conversion on the entity object set according to the object list to obtain an entity object attribute set of the DeepWeb.

3. The DeepWeb entity recognition method based on a uniqueness constraint of claim 1, wherein the calculating a matching degree between entity objects in the entity object attribute set comprises:
extracting a target entity object with same attribute value in the entity object attribute set, and acquiring the number of attributes of the target entity object;
calculating a target matching degree of the target entity object according to the number of attributes and the same attribute value using the following formula, and determining a matching degree between the entity objects according to the target matching degree;
$$Mat ( {O}_{1} , {O}_{2} ) = \frac{\vert {O}_{1} ∩ {O}_{2} \vert}{\vert {O}_{1} \vert + \vert {O}_{2} \vert - \vert {O}_{1} ⋂ {O}_{2} \vert}$$
wherein, Mat(O₁, O₂) represents the target matching degree between target entity objects O₁, O₂, |O₁∩O₂| represents the number of identical attribute values between target entity objects O₁, O₂, |O₁|O₁| represents the number of attributes in the target entity objects O₁, and |O₂| represents the number of attributes in the target entity objects O₂.

4. The DeepWeb entity recognition method based on a uniqueness constraint of claim 1, wherein constructing a matching list of the entity object set according to the matching degree comprises:
extracting a matching entity object of each entity object from the entity object set according to the matching degree, and sorting the matching entity objects according to the numerical value of the matching degree to obtain a matching object sequence of each entity object;
constructing an initial matching list of each of the entity objects according to the matching object sequence, and combining the initial matching lists to obtain a matching list of the entity object set.

5. The DeepWeb entity recognition method based on a uniqueness constraint of claim 1, wherein the using a pre-set matching degree threshold value to filter the matching list to obtain an entity class cluster of the entity object set comprises:
searching a matching relationship of each entity object from the matching list, and when the matching relationship is a multi-matching relationship, acquiring a matching degree of each matching relationship;
deleting a matching relationship corresponding to the matching degree to obtain an updated matching list when the matching degree is less than a pre-set matching degree threshold value;
classifying the entity object set according to the updated matching list to obtain an entity class cluster of the entity object set.

6. The DeepWeb entity recognition method based on a uniqueness constraint of claim 1, wherein the calculating an object similarity degree of each entity object in the entity class cluster comprises:
calculating an attribute occurrence frequency of a target entity attribute corresponding to each entity object in the entity class cluster, and calculating an attribute weight of the target entity attribute according to the attribute occurrence frequency;
calculating an attribute similarity degree between the target entity attributes according to the data type of the target entity attributes using the following formula;
$$Sim ( {a}_{1} , {a}_{2} ) = \{ \begin{matrix}\vert {a}_{1} ⋂ {a}_{2} \vert / \vert {a}_{1} ⋃ {a}_{2} \vert & {a}_{1} , {a}_{2} is numeric type \\ \vert {a}_{1} ⋂ {a}_{2} \vert / min ( \vert {a}_{1} \vert , \vert {a}_{2} \vert ) & {a}_{1} , {a}_{2} is character type \\ 1 & others\end{matrix}$$
wherein, Sim(a₁, a₂) represents the attribute similarity degree between the target entity attributes a₁, a₂, |a₁∩a₂| represents the absolute value of the intersection set of the target entity attributes a₁, a₂, |a₁∪a₂| represents the absolute value of the union set of the target entity attributes a₁, a₂, and min(|a₁|, |a₂|) represents the minimum value of the absolute values of the target entity attributes a₁, a₂;
calculating an object similarity degree of each entity object in the entity class cluster according to the attribute weight and the attribute similarity degree.

7. The DeepWeb entity recognition method based on a uniqueness constraint of claim 6, wherein the calculating an object similarity degree of each entity object in the entity class cluster according to the attribute weight and the attribute similarity degree comprises:
calculating an object similarity degree of each entity object in the entity class cluster using the following formula:
$$Sim ( {P}_{1} , {P}_{2} ) = \frac{{\sum }_{i = 1}^{I} {w}_{i} * max ( {Sim}_{i} ( {P}_{1} , {P}_{2} ) )}{min ( \vert {P}_{1} \vert , \vert {P}_{2} \vert )}$$
wherein, Sim(P₁, P₂) represents the object similarity degree between entity objects P₁, P₂ in an entity class cluster, Simᵢ(P₁, P₂) represents the attribute similarity degree between a i^{th} target entity attribute and other target entity attributes in the entity objects P₁, P₂, i represents the i^{th} target entity attribute in the entity objects P₁, P₂, I represents the total of target number entity attributes, max(Simᵢ(P₁, P₂)) represents the maximum value of the attribute similarity degree between the i^{th} target entity attribute and other target entity attributes in the entity objects P₁, P₂, wᵢ represents the attribute weight corresponding to the i^{th} target entity attribute in the entity objects P₁, P₂, |P₁| represents the number of attributes in the entity object P₁ in the entity class cluster, and |P₂| represents the number of attributes in the entity object P₂ in the entity class cluster.

8. An electronic device, the electronic device comprising:
at least one processor; and
a memory communicatively connected to the at least one processor;
wherein,
the memory stores a computer program executable by the at least one processor, the computer program is executed by the at least one processor to enable the at least one processor to execute the steps of:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

9. The electronic device of claim 8, wherein the performing structure conversion on the entity object set to obtain an entity object attribute set of the DeepWeb comprises:
acquiring an attribute list of each entity object in the entity object set, and extracting an object list with same attribute value in the attribute list;
performing attribute structure conversion on the entity object set according to the object list to obtain an entity object attribute set of the DeepWeb.

10. The electronic device of claim 8, wherein the calculating a matching degree between entity objects in the entity object attribute set comprises:
extracting a target entity object with same attribute value in the entity object attribute set, and acquiring the number of attributes of the target entity object;
calculating a target matching degree of the target entity object according to the number of attributes and the same attribute value using the following formula, and determining a matching degree between the entity objects according to the target matching degree;
$$Mat ( {O}_{1} , {O}_{2} ) = \frac{\vert {O}_{1} ∩ {O}_{2} \vert}{\vert {O}_{1} \vert + \vert {O}_{2} \vert - \vert {O}_{1} ⋂ {O}_{2} \vert}$$
wherein, Mat(O₁, O₂) represents the target matching degree between target entity objects O₁, O₂, |O₁∩O₂| represents the number of identical attribute values between target entity objects O₁, O₂, |O₁| represents the number of attributes in the target entity objects O₁, and |O₂| represents the number of attributes in the target entity objects O₂.

11. The electronic device of claim 8, wherein the constructing a matching list of the entity object set according to the matching degree comprises:
extracting a matching entity object of each entity object from the entity object set according to the matching degree, and sorting the matching entity objects according to the numerical value of the matching degree to obtain a matching object sequence of each entity object;
constructing an initial matching list of each of the entity objects according to the matching object sequence, and combining the initial matching lists to obtain a matching list of the entity object set.

12. The electronic device of claim 8, wherein the using a pre-set matching degree threshold value to filter the matching list to obtain an entity class cluster of the entity object set comprises:
searching a matching relationship of each entity object from the matching list, and when the matching relationship is a multi-matching relationship, acquiring a matching degree of each matching relationship;
deleting a matching relationship corresponding to the matching degree to obtain an updated matching list when the matching degree is less than a pre-set matching degree threshold value;
classifying the entity object set according to the updated matching list to obtain an entity class cluster of the entity object set.

13. The electronic device of claim 8, wherein the calculating an object similarity degree of each entity object in the entity class cluster comprises:
calculating an attribute occurrence frequency of a target entity attribute corresponding to each entity object in the entity class cluster, and calculating an attribute weight of the target entity attribute according to the attribute occurrence frequency;
calculating an attribute similarity degree between the target entity attributes according to the data type of the target entity attributes using the following formula;
$$Sim ( {a}_{1} , {a}_{2} ) = \{ \begin{matrix}\vert {a}_{1} ⋂ {a}_{2} \vert / \vert {a}_{1} ⋃ {a}_{2} \vert & {a}_{1} , {a}_{2} is numeric type \\ \vert {a}_{1} ⋂ {a}_{2} \vert / min ( \vert {a}_{1} \vert , \vert {a}_{2} \vert ) & {a}_{1} , {a}_{2} is character type \\ 1 & others\end{matrix}$$
wherein, Sim(a₁, a₂) represents the attribute similarity degree between the target entity attributes a₁, a₂, |a₁∩a₂| represents the absolute value of the intersection set of the target entity attributes a₁, a₂, |a₁∪a₂| represents the absolute value of the union set of the target entity attributes a₁, a₂, and min(|a₁|, |a₂|) represents the minimum value of the absolute values of the target entity attributes a₁, a₂;
calculating an object similarity degree of each entity object in the entity class cluster according to the attribute weight and the attribute similarity degree.

14. The electronic device of claim 13, wherein the calculating an object similarity degree of each entity object in the entity class cluster according to the attribute weight and the attribute similarity degree comprises:
calculating an object similarity degree of each entity object in the entity class cluster using the following formula:
$$Sim ( {P}_{1} , {P}_{2} ) = \frac{{\sum }_{i = 1}^{I} {w}_{i} * max ( {Sim}_{i} ( {P}_{1} , {P}_{2} ) )}{min ( \vert {P}_{1} \vert , \vert {P}_{2} \vert )}$$
wherein, Sim(P₁, P₂) represents the object similarity degree between entity objects P₁, P₂ in an entity class cluster, Simᵢ(P₁, P₂) represents the attribute similarity degree between a i^{th} target entity attribute and other target entity attributes in the entity objects P₁, P₂, i represents the i^{th} target entity attribute in the entity objects P₁, P₂, I represents the total number of target entity attributes, max(Simᵢ(P₁, P₂)) represents the maximum value of the attribute similarity degree between the i^{th} target entity attribute and other target entity attributes in the entity objects P₁, P₂, wᵢ represents the attribute weight corresponding to the i^{th} target entity attribute in the entity objects P₁, P₂, |P₁| represents the number of attributes in the entity object P₁ in the entity class cluster, and |P₂| represents the number of attributes in the entity object P₂ in the entity class cluster.

15. A non-volatile computer-readable storage medium storing a computer program, the computer program when executed by a processor realizing the following steps:
acquiring an entity object set in a DeepWeb, and performing structure conversion on the entity object set to obtain an entity object attribute set of the DeepWeb;
calculating a matching degree between entity objects in the entity object attribute set, and constructing a matching list of the entity object set according to the matching degree;
using a pre-set matching degree threshold value to filter the matching list to obtain an entity class cluster of the entity object set;
calculating an object similarity degree of each entity object in the entity class cluster, and merging the entity class cluster according to the object similarity degree to obtain an entity class set of the entity object set;
searching a uniqueness constraint corresponding to each entity object in the entity object set according to the entity class set, and recognizing an entity object in the DeepWeb according to the uniqueness constraint.

16. The non-volatile computer-readable storage medium of claim 15, wherein the calculating a matching degree between entity objects in the entity object attribute set comprises:
extracting a target entity object with same attribute value in the entity object attribute set, and acquiring the number of attributes of the target entity object;
calculating a target matching degree of the target entity object according to the number of attributes and the same attribute value using the following formula, and determining a matching degree between the entity objects according to the target matching degree;
$$Mat ( {O}_{1} , {O}_{2} ) = \frac{\vert {O}_{1} ∩ {O}_{2} \vert}{\vert {O}_{1} \vert + \vert {O}_{2} \vert - \vert {O}_{1} ⋂ {O}_{2} \vert}$$
wherein, Mat(O₁, O₂) represents the target matching degree between target entity objects O₁, O₂, |O₁∩O₂| represents the number of identical attribute values between target entity objects O₁, O₂, |O₁| represents the number of attributes in the target entity objects O₁, and |O₂| represents the number of attributes in the target entity objects O₂.

17. The non-volatile computer-readable storage medium of claim 15, wherein the constructing a matching list of the entity object set according to the matching degree comprises:
extracting a matching entity object of each entity object from the entity object set according to the matching degree, and sorting the matching entity objects according to the numerical value of the matching degree to obtain a matching object sequence of each entity object;
constructing an initial matching list of each of the entity objects according to the matching object sequence, and combining the initial matching lists to obtain a matching list of the entity object set.

18. The non-volatile computer-readable storage medium of claim 15, wherein the using a pre-set matching degree threshold value to filter the matching list to obtain an entity class cluster of the entity object set comprises:
searching a matching relationship of each entity object from the matching list, and when the matching relationship is a multi-matching relationship, acquiring a matching degree of each matching relationship;
deleting a matching relationship corresponding to the matching degree to obtain an updated matching list when the matching degree is less than a pre-set matching degree threshold value;
classifying the entity object set according to the updated matching list to obtain an entity class cluster of the entity object set.

19. The non-volatile computer-readable storage medium of claim 15, wherein the calculating an object similarity degree of each entity object in the entity class cluster comprises:
calculating an attribute occurrence frequency of a target entity attribute corresponding to each entity object in the entity class cluster, and calculating an attribute weight of the target entity attribute according to the attribute occurrence frequency;
calculating an attribute similarity degree between the target entity attributes according to the data type of the target entity attributes using the following formula;
$$Sim ( {a}_{1} , {a}_{2} ) = \{ \begin{matrix}\vert {a}_{1} ⋂ {a}_{2} \vert / \vert {a}_{1} ⋃ {a}_{2} \vert & {a}_{1} , {a}_{2} is numeric type \\ \vert {a}_{1} ⋂ {a}_{2} \vert / min ( \vert {a}_{1} \vert , \vert {a}_{2} \vert ) & {a}_{1} , {a}_{2} is character type \\ 1 & others\end{matrix}$$
wherein, Sim(a₁, a₂) represents the attribute similarity degree between the target entity attributes a₁, a₂, |a₁∩a₂| represents the absolute value of the intersection set of the target entity attributes a₁, a₂, |a₁∪a₂| represents the absolute value of the union set of the target entity attributes a₁, a₂, and min(|a₁|, |a₂|) represents the minimum value of the absolute values of the target entity attributes a₁, a₂;
calculating an object similarity degree of each entity object in the entity class cluster according to the attribute weight and the attribute similarity degree.

20. The non-volatile computer-readable storage medium of claim 19, wherein the calculating an object similarity degree of each entity object in the entity class cluster according to the attribute weight and the attribute similarity degree comprises:
calculating an object similarity degree of each entity object in the entity class cluster using the following formula:
$$Sim ( {P}_{1} , {P}_{2} ) = \frac{{\sum }_{i = 1}^{I} {w}_{i} * max ( {Sim}_{i} ( {P}_{1} , {P}_{2} ) )}{min ( \vert {P}_{1} \vert , \vert {P}_{2} \vert )}$$
wherein, Sim(P₁, P₂) represents the object similarity degree between entity objects P₁, P₂ in an entity class cluster, Simᵢ(P₁, P₂) represents the attribute similarity degree between a i^{th} target entity attribute and other target entity attributes in the entity objects P₁, P₂, i represents the i^{th} target entity attribute in the entity objects P₁, P₂, I represents the total number of target entity attributes, max(Simᵢ(P₁, P₂)) represents the maximum value of the attribute similarity degree between the i^{th} target entity attribute and other target entity attributes in the entity objects P₁, P₂, wᵢ represents the attribute weight corresponding to the i^{th} target entity attribute in the entity objects P₁, P₂, |P₁| represents the number of attributes in the entity object P₁ in the entity class cluster, and |P₂| represents the number of attributes in the entity object P₂ in the entity class cluster.
